(19) United States
(12) Patent Application Publication
(10) Pub. No.: US 2015/0249848 A1
(43) Pub. Date: Sep. 3, 2015

(54) Intelligent Video Quality Adjustment

(71) Applicant: Apple Inc., Cupertino, CA (US)

(72) Inventor: Tomlinson Holman, Cupertino, CA (US)

(21) Appl. No.: 14/503,070

(22) Filed: Sep. 30, 2014

Related U.S. Application Data
(60) Provisional application No. 61/946,490, filed on Feb. 28, 2014.

(51) Int. Cl. H04N 21/2343; H04N 21/4402; H04N 7/015

(52) U.S. Cl. CPC H04N 21/23439; H04N 7/015; H04N 21/44029

(57) ABSTRACT

A method for streaming video content is described. Several device parameters are received from a user device. The device parameters define video display capability of the user device. The method selects a video format for a video containing the video content from several available video formats based on the device parameters and based on contextual information of the video content. In one embodiment, in order to select the video format, the method assigns a weight to each video quality parameter based on the contextual information of the video content and selects the video format based on the weights assigned to the different video quality parameters. The method retrieves video containing the content in the selected video format from a media library. The method sends the video containing the content in the selected video format into a packet-switched data communication network. Other embodiments are also described and claimed.

### RELATED MATTERS

This application claims the benefit of the earlier filing date of U.S. Provisional Application No. 61/946,490, filed Feb. 28, 2014, entitled “Intelligent Video Quality Adjustment”.

### FIELD

An embodiment of the invention is related to digital video content delivery and display techniques, and particularly to techniques for improving video quality by providing feedback to upstream processes in the video chain. Other embodiments are also described.

### BACKGROUND

Digital media was popularized using only a limited number of formatting parameters out of all formatting parameters that were available. For example, the audio compact disc (CD) was popularized as a two-channel 16-bit pulse-code modulation (PCM) encoding at a 44.1 kHz sampling rate per channel. However, there was a four-channel variant in the Red Book standard that few people know of because it was never implemented and used widely. Additionally, there was a high-frequency pre-emphasis upon record and de-emphasis upon playback to reduce noise as an option that was never widely used. In television, high-definition television (HDTV) standardized a table of 19 different formats. Only about three of the 19 formats ever saw widespread use, likely owing to the difficulty of reaching an agreement among various stakeholders and the complexity of dealing with a large number of different formats.

Currently, 4K resolution (4K) is being marketed to the consumer as the next big step for display devices and content, in the fields of digital television and digital cinematography. The television industry has adopted ultra-high definition television (UHDTV) as its “4K” standard. However, as the International Broadcasting Convention (IBC) conference sessions have indicated, 4K in and of itself is not sufficient to produce the sensation of a whole new experience that is needed to make a major impact on the market.

Delivery of video content has advanced by making picture quality adaptable to the bit rate available to any given subscriber. For example, for some online video streaming services, the picture quality lies not in the number of pixels in the image, which remains typically at 1920×1080 progressively scanned over a variety of picture qualities. What typically varies with different available bit rates is the amount of compression, so that subscribers with higher bit rate connections can enjoy a better picture. The streaming video provided by these services may be all high-definition (HD) in terms of resolution or pixel count, but it is HD scaled with compression to the capabilities of the delivery, or even delivered with less resolution to maintain the connection and enhance the user experience by producing pictures continuously, albeit of potentially varying quality. While providing streaming video with variable bit rate is well known in the art, picture quality parameters such as bit depth, color gamut, and frame rate, have always been standardized to one value across a potential range of compression ratios

Further, streaming video with higher bit rates has become more widely available as time goes by. For example, Data Over Cable Service Interface Specification (DOCSIS) 3.0 is currently being deployed by cable companies, with 18 Mbps chunks deliverable to a wide base of homes, and multiple chunks to each subscriber possible. Video compression has also improved. The ITU-T H.265 standard is new on the scene, offering an improvement in bit rate reduction at the same quality, or greater quality at the same bit rates, over the ten-year-old H.264 format which itself offered an improvement of picture quality at lower bit rates over the twenty-year-old MPEG-2 standard used for over-the-air Advanced Television Systems Committee (ATSC).

### SUMMARY

A method for delivering desired video content over a packet-switching data communications network is described. Several device parameters are received from a user device. The device parameters define a capability of the user device in handling different video quality parameters. A video format is selected from several available video formats, based on the received device parameters and based on contextual information of the video content. In one embodiment, in order to select the video format, a weight is assigned to each video quality parameter based on the contextual information of the video content. The video format is then selected based on the weights assigned to the different video quality parameters. Video, containing the desired video content in the selected video format, is retrieved from a media library and then delivered to the user device.

A method for streaming video content is described. In one embodiment, the video content being streamed is live video content. The method receives multiple parameters defining a connection quality of users subscribed to receive the video content. The method selects a video format for a video containing the video content from several available video formats based on the parameters and based on contextual information of the video content. In one embodiment, in order to select the video format, the method assigns a weight to each video quality parameter based on the contextual information of the video content, and selects the video format based on the weights assigned to the different video quality parameters. The method captures the video containing the video content in the selected video format before delivering the video containing the video content to a content server.

A system for delivering desired video content is described. The system includes a processor and video format selection logic. The video format selection logic is to receive several device parameters from a user device. The device parameters define a capability of the user device in handling different video quality parameters. The video format selection logic is to select a video format for a video containing the desired video content from several video formats based on the device parameters and based on contextual information of the desired video content. In one embodiment, in order to select the video format, the video format selection logic is to assign a weight to each video quality parameter based on the contextual information of the desired video content, and select the video format based on the weights assigned to different video quality parameters. The video format selection logic is further to retrieve the video containing the desired video content in the selected video format from a media library. The video format selection logic is to stream the video containing the desired video content in the selected video format to the user device over a packet-switching data communication network.

A system for streaming video content is described. In one embodiment, the video content being streamed is live video content. The system includes a processor, a parameter determination logic, and a video capture unit. The parameter determination logic is to select a video format for a video containing video content from several video formats based on several parameters defining a connection quality of users subscribed to receive the video content and based on contextual information of the video content. In one embodiment, the parameters include a maximum bit rate that can be sustained to any one subscriber to the video content. In one embodiment, in order to select the video format, the parameter determination logic is to assign a weight to each video quality parameter based on the contextual information of the video content, and select the video format based on the weights assigned to different video quality parameters. The video capture unit is to capture the video containing the video content in the selected video format. The video capture unit is further to deliver the video containing the video content to a content server. In one embodiment, the video capture unit is to convert the video containing the video content from the selected video format into a set of video formats.

In one embodiment, the video quality parameters include one or more of codec, frame rate, contrast, brightness, resolution, bit depth, Electronic-to-Optical Transfer Function (EOTF), and color gamut. In one embodiment, the contextual information specifies content type of the desired video content. The content types may include feature film, sports, documentary, talk show, television comedy, and reality show.

The above summary does not include an exhaustive list of all aspects of the invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The present invention is illustrated by way of example and not limitation in the figures of the accompanying drawings in which like references indicate similar elements.

FIG. 1 illustrates an overview diagram of a system that adjusts video quality based on parameter feedback given to upstream processes in the video distribution chain.

FIG. 2A illustrates a multidimensional diagram representing parameter preferences for movies.

FIG. 2B illustrates a multidimensional diagram representing parameter preferences for sports events.

FIG. 3 illustrates a detailed diagram of a system that adjusts video format based on video quality parameters of user devices.

FIG. 4 illustrates a flowchart of operations performed in a content server.

FIG. 5 illustrates a detailed diagram of a system that can adjust original video format at source capture of a video.

FIG. 6 illustrates a flowchart of operations performed in a content producer.

FIG. 7 shows an example of a data processing system that may be used with one embodiment of the invention.

### DETAILED DESCRIPTION

A system that adjusts video quality intelligently by having feedback to upstream processes in the video distribution chain, and with the content in mind, is described. In the following description, numerous specific details are set forth to provide thorough explanation of embodiments of the invention. It will be apparent, however, to one skilled in the art, that embodiments of the invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow are performed by processing logic that comprises hardware (e.g., circuitry, dedicated logic, etc.), software (such as is run on a general-purpose device or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Rather than making one decision about video quality at the beginning of the video distribution chain, one embodiment of the invention has deliberate feedback given as far back as possible in the video distribution chain, for example as far back as the source capture (e.g., in a live context), to affect the picture quality intelligently, and with the content in mind. In one embodiment, one stream is picked from a plurality of streams coming from the camera that represents its highest domain, or from some standard down-converters (such as, e.g., in a truck at the Super Bowl) downrezing all the cameras to a variety of outputs. For example, sports content may use a higher frame rate than a movie to achieve a smoother representation of motion, but probably does not need as much dynamic range. A movie on the other hand, is unlikely to make use of anything over 24 frames per second, whereas dynamic range is highly valuable, especially in movies lit with low-key lighting. In one embodiment, parameters about a user device's capability in displaying video is provided to the content server, along with the program contextual information, to determine an optimal video format for streaming the video to the user device. In one embodiment, the maximum bit rate that can be sustained to any one subscriber and the program contextual information are used to determine the original video format for source capture. In one embodiment, a back channel transmitting parameters about the user device or the connection quality can be used to control the forward channel, which streams the video. The back channel controls the forward channel by modifying video format at the content server or at the time of source capture.

A traditional media streaming communications protocol (e.g., HTTP Live Streaming) starts playback at a bit rate this is considered sustainable. During the playback, the traditional media streaming communications protocol ratchets up or down the bit rate according to the channel capacity. For example, if a higher bit rate can be sustained then the higher bit rate is used. If the current bit rate results in packet loss then a different selection of bit rate encoded content at a lower peak bit rate is chosen. Usually the same codec at different bit rates are used and the selection of different streaming formats is not affected by capability parameters of the video playing device. One embodiment of the present disclosure straddles the traditional media streaming communications protocol, with more different input parameters coming from the video playing device in selecting from different alternate streaming formats. For example, a user may receive a steaming format that has better video quality because he/she has a better video playing device, which does not happen if a traditional media streaming communications protocol (e.g., HTTP Live Streaming) is used. This provides an incentive for the whole market to migrate to better picture quality.

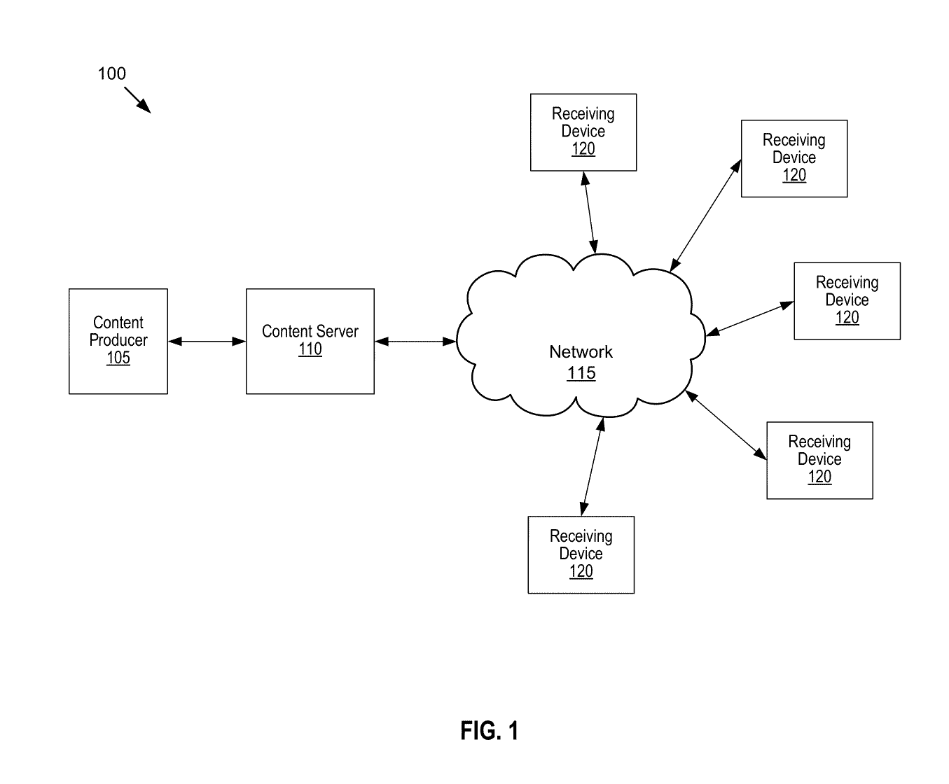

FIG. 1 illustrates an overview diagram of a system 100 that adjusts video quality by having feedback to upstream processes in the video distribution chain in accordance with one embodiment of the invention. Specifically, the system 100 includes a content producer 105, a content server 110, and several receiving devices 120, wherein the content server 110 streams video to the receiving devices 120 through a communications network 115. In one embodiment, the upstream processes are the source capture of the video at the content producer 105 and the delivery of the video at the content server 100.

The content producer 105 produces video content by capturing video and stores the video in a specific video format. Once a video is captured, it is put on the content server 110 for distribution. The content server 110 is a content transmission device that stores media content and receives requests from other devices for the media content. Once a request is received and processed, the content server 110 converts the requested media content into a bit stream and sends it to the requesting party, e.g., the receiving device 120. The content server 110 transmits data to another device through a connection between the two devices over the network 115. In one embodiment, the network 115 is a packet switched network such as the Internet. Some examples of a content server 110 include an electronic device such as a server, a desktop, a laptop, a netbook, a tablet computer, a smartphone, etc. that is capable of sending and receiving data to and from another device. In some cases, one or more devices provide the requested media content. The content server 110 could also be part of a content delivery network (CDN). A CDN is a system of computers containing copies of data placed at various nodes of a network.

The receiving devices 120 are user devices that receive video stream from the content server 110 and play back the received video to the user. The content server 110 and a receiving device 120 establish a connection over the network 115 and start a communication session by exchanging data. By its own initiative (i.e., based on user inputs), the receiving device 120 requests a piece of media content from the content server 110. After receiving the request, the content server 110 generates the bit stream enclosing the requested piece of media content and sends the bit stream to the receiving device 120 over the network 115.

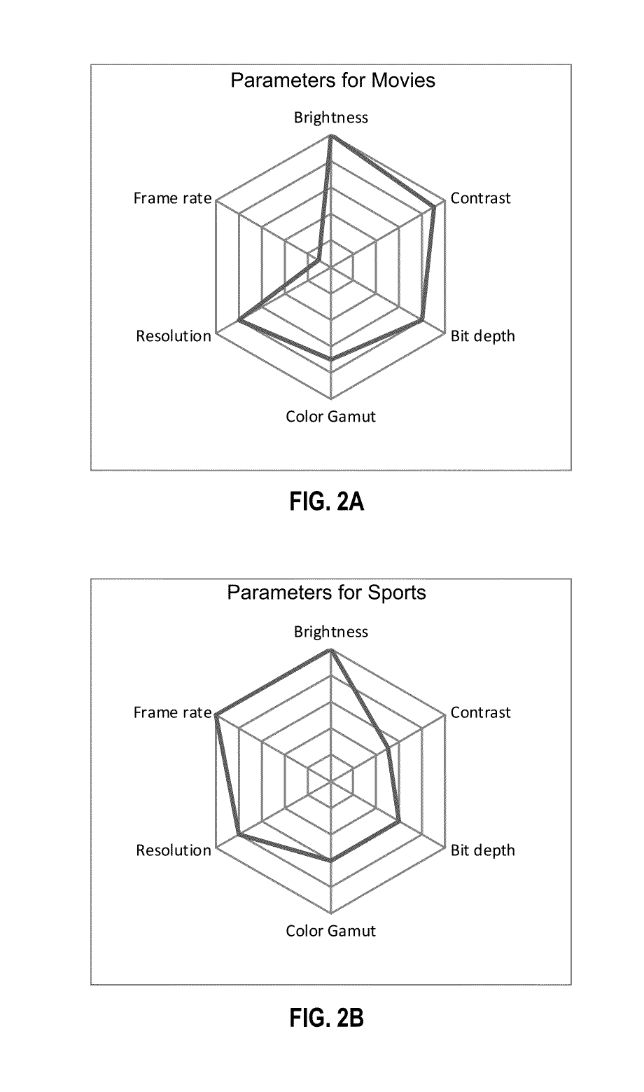

FIGS. 2A and 2B illustrate two multidimensional diagrams, each with six cardinal points corresponding to frame rate, brightness, contrast, bit depth, color gamut, and resolution of a video. A cardinal point near the center of the diagram represents a relatively low quality requirement for the corresponding attribute of the video. The closer the cardinal point to the center of the diagram, the lower the quality requirement for the corresponding attribute. A cardinal point near the edge of the diagram represents a relatively high quality requirement for the corresponding attribute of the video. The closer the cardinal point to the edge of the diagram, the higher the quality requirement for the corresponding attribute.

FIG. 2A illustrates an example of parameter preferences for movies. As illustrated in the figure, movies usually have a low quality requirement for frame rate because most movies are recorded at 24 frames per second. But movies have high quality requirements for parameters like contrast because, for example, 14-bit-transferred film elements require high contrast for getting highlight and shadow details (the resolution for most video is only 8-bit). Brightness, bit depth, color gamut, and resolution, for example, also have relatively high quality requirement for movies.

When the video is sports programming, the whole shape of the diagram is completely different. FIG. 2B illustrates an example of parameter preferences for sports events. As illustrated in the figure, sports have high quality requirements for frame rate and brightness, while bit depth to represent a wide dynamic range and contrast are not so important as with movies.

Therefore, a content subscriber would prefer a brighter picture for a sports video, and would definitely need a higher frame rate that he would not need for movies. However, every user device has its limitation regarding the highest quality of video it can display. Therefore, one embodiment of the invention is for the user device to tell the content server what kind of frame rate it can handle, how much dynamic range it can reproduce, how much color space it has, and so on. The content server adjusts the video format based on the parameters it received from the user device and based on the type of video content. In one embodiment, there is a back channel for transmitting the video quality parameters from the user device to the content server. The back channel is a low bit rate connection that sends metadata about the video quality that the user device can handle to the content server so that the content server can send the user device the best quality video that the user device can accept.

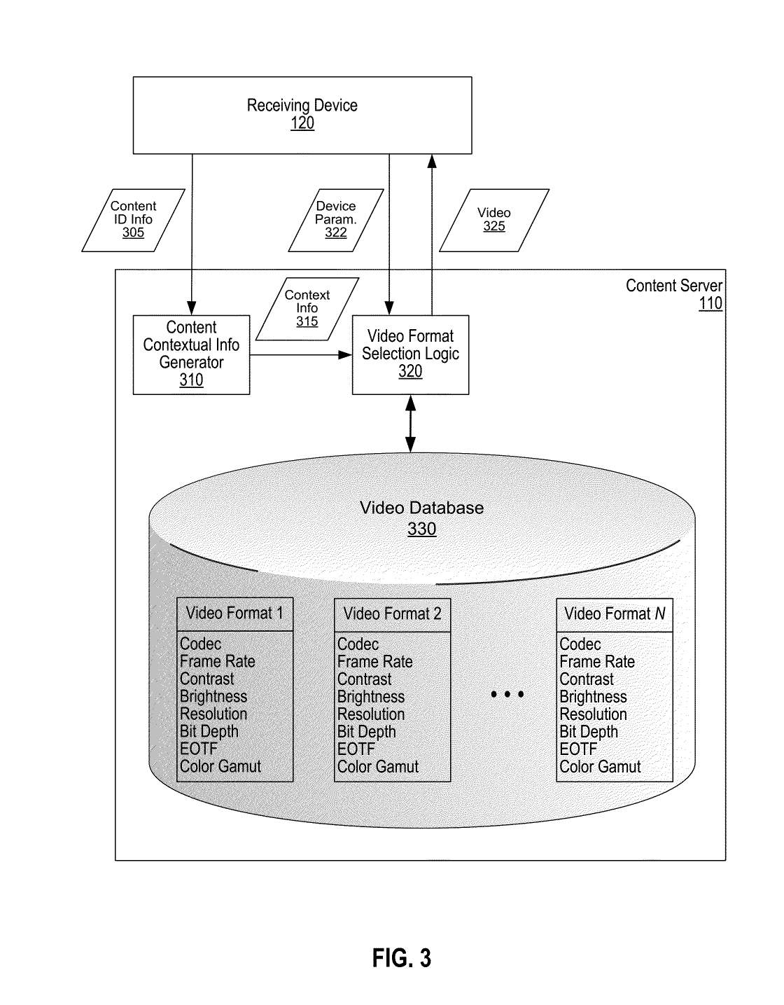

FIG. 3 illustrates a detailed diagram of a system that adjusts video format based on video quality parameters of user devices in accordance with one embodiment of the invention. Specifically, this figure shows a receiving device 120 connected to a content server 110 through a communication network (not shown). The content server 110 includes a content contextual information generator 310, a video format selection logic 320, and a video database 330.

The content contextual information generator 310 receives content identification information 305 for the desired content from the receiving device 120 and generates contextual information 315 for the desired content accordingly. In one embodiment, the contextual information 315 is the content type of a video containing the desired content, e.g., feature film, sports, documentary, talk show, television comedy, reality show, etc. In one embodiment, the content contextual information generator 310 may generate the contextual information 315 without receiving the content identification information 305 from the receiving device 120.

The video format selection logic 320 receives device parameters 322 from the receiving device 120. The device parameters 322 define a capability of the receiving device 120 in handling different video quality parameters. In one embodiment, the device parameters 322 may include the codec, the frame rate, contrast, brightness, resolution, bit depth, Electronic-to-Optical Transfer Function (EOTF), and color gamut that the receiving device 120 can display. In one embodiment, the video format selection logic 320 also receives contextual information 315 from the content contextual information generator 310. The video format selection logic 320 selects an optimal video format for a video containing the desired content from multiple available video formats in the video database 330 based on the device parameters 322 and the contextual information 315. The video format selection logic 320 assigns different weight to each video quality parameter based on the contextual information 315. The video format selection logic 320 then selects the optimal video format based on the different weights, e.g., by selecting a video format that best matches the weights assigned to different video quality parameters. The video format selection logic 320 retrieves a video 325 containing the desired content in the selected optimal video format from the video database 330 and sends the video 325 to the receiving device 120.

In one embodiment, the video format selection logic 320 also considers the bandwidth of the connection between the receiving device 120 and the content server 110 in determining the optimal video format. When the bandwidth is limited, the video format selection logic 320 uses a scale function for the importance of each video quality parameter to determine how much each video quality parameter can be degraded. In one embodiment, the scale function is derived partially based on the contextual information 315 of the desired video content. For example, different weights are assigned to each video quality parameter based on the contextual information 315, and the more weights a video quality parameter is assigned, the less the video quality parameter is to be degraded.

In one embodiment, the video database 330 stores multiple versions of each video. For example, and as illustrated in FIG. 3, the video database 330 stores video formats 1-N for a video. Each video format is defined by parameters such as codec, frame rate, contrast, brightness, resolution, bit depth, EOTF, and color gamut. The codec is a coding or compression format used for the video. In one embodiment, the video database 330 stores the best version of the video, i.e., the video format with the highest quality, and stores different codecs to convert it into video formats of lower quality. The bit depth specifies the number of bits used for each color component. More bits within a particular dynamic range results in less likelihood of seeing “color banding” (quantization error), which is a problem of inaccurate color presentation in video display. More bits could also be expended on a wider dynamic range. If a wider dynamic range is used, then there is a corresponding need for more bits to maintain constant, and hopefully invisible, quantization error. The color gamut is a certain complete subset of colors that can be accurately represented by a certain output device, or the complete set of colors found within the video. In one embodiment, the color gamut is the range of color that may be portrayed by a given display device, which is related to the chromaticity coordinates of the color primaries of the display.

In one embodiment, the receiving device 120 lets the content server 110 know that the display of the receiving device 120 is capable of handling various color gamut such as Rec. 709, DCI P3, Rec. 2020, etc. The content server 110 then chooses a corresponding video format. Movies for instance are in DCI P3 space, larger than HDTVs Rec. 709. So an ordinary HDTV needs a video format with the limited color gamut of ITU-R Rec. BT.709, while a DCI P3 or ITU-R Rec. BT.2020 device can use the DCI P3 video format directly.

The receiving device 120 and the content server 110 are described above for one embodiment of the invention. One of ordinary skill in the art will realize that in other embodiments, this system can be implemented differently. For instance, in one embodiment described above, certain modules are implemented as software modules. However, in another embodiment, some or all of the modules might be implemented by hardware, which can be dedicated application specific hardware (e.g., an application specific integrated circuit, ASIC, chip or component) or a general purpose chip (e.g., a microprocessor or field programmable gate array, FPGA).

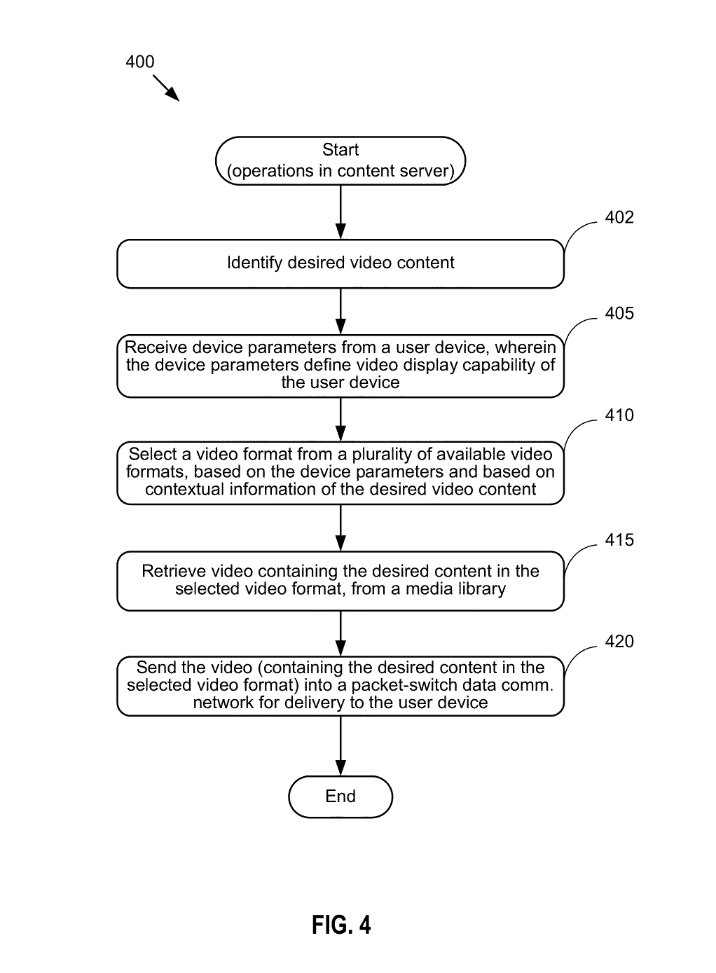

FIG. 4 illustrates a flowchart of operations performed in a content server, referred to as process 400. In one embodiment, the content server (e.g., the content server 110 of FIG. 1 or FIG. 3) executes process 400 when a video request is initiated. As illustrated in FIG. 4, process 400 begins by identifying (at block 402) video content that is desired by the user, i.e., the program that the user wants to watch.

At block 405, process 400 receives several device parameters from a user device (e.g., the receiving device 120 of FIG. 1 or FIG. 3). The device parameters define a capability of the user device in handling different video quality parameters. In one embodiment, the device parameters may include the codec, the frame rate, contrast, brightness, resolution, bit depth, EOTF, and color gamut that the user device can handle.

At block 410, process 400 selects a video format from several available video formats based on the received device parameters of the user device and based on contextual information of the desired video content. In one embodiment, the contextual information is the content type of the video, e.g., feature film, sports, documentary, talk show, television comedy, reality show, etc. Process 400 assigns different weights to each video quality parameter based on the contextual information of the video content. Process 400 then selects the optimal video format based on the different weights, e.g., by selecting a video format that best matches the weights assigned to different video quality parameters. In one embodiment, process 400 also considers the bandwidth of the connection between the user device and the content server in determining the optimal video format. When the bandwidth is limited, process 400 uses a scale function for the importance of each video quality parameter to determine how much each video quality parameter can be degraded. In one embodiment, the scale function is derived partially based on the contextual information of the video content. For example, different weights are assigned to each video quality parameter based on the contextual information, and the more weights a video quality parameter is assigned, the less the video quality parameter is to be degraded.

At block 415, process 400 retrieves the video containing the desired content in the selected video format from a media library (e.g., the video database 330 of FIG. 3). At block 420, process 400 sends the video containing the desired content in the selected video format into a packet-switching data communication network for delivery to the user device.

One of ordinary skill in the art will recognize that process 400 is a conceptual representation of the operations executed by the content server to stream video to the user device. The specific operations of process 400 may not be performed in the exact order shown and described. The specific operations may not be performed in one continuous series of operations, and different specific operations may be performed in different embodiments. Furthermore, process 400 could be implemented using several sub-processes, or as part of a larger macro process.

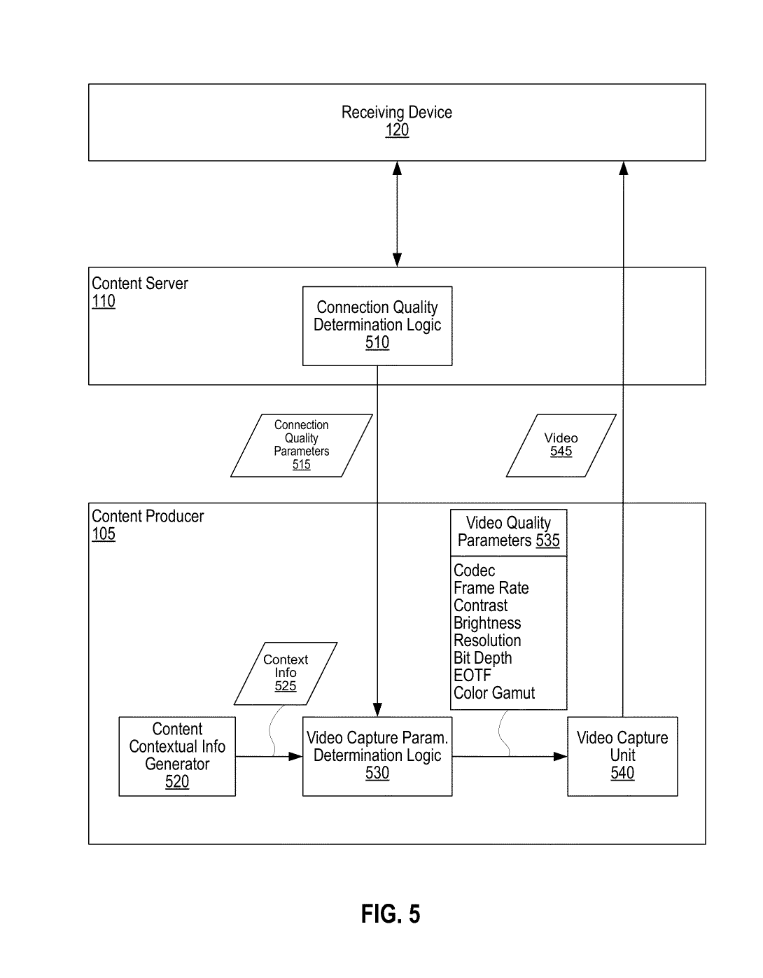

FIG. 5 illustrates a detailed diagram of a system that can adjust original video format at source capture of video content in accordance with one embodiment of the invention. In one embodiment, the video content is captured and streamed live. Specifically, this figure shows a receiving device 120 connected to a content server 110 through a communication network (not shown), and the content server connected to a content producer 105. The content server 110 includes connection quality determination logic 510. The content producer 105 includes a content contextual information generator 520, a video capture parameter determination logic 530, and a video capture unit 540.

The connection quality determination logic 510 of the content server 110 determines a set of connection quality parameters 515 for all the receiving devices requesting video content. In one embodiment, the set of connection quality parameters 515 includes the maximum bit rate that can be sustained to any one subscriber to the video content. The connection quality determination logic 510 sends the set of connection quality parameters 515 to the video capture parameter determination logic 530 of the content producer 105.

The content contextual information generator 520 of the content producer 105 generates contextual information 525. In one embodiment, the contextual information 525 is the content type of the desired video content, e.g., sports, talk show, reality show, etc.

The video capture parameter determination logic 530 receives the set of connection quality parameters 515 from the connection quality determination logic 510 of the content server 110 and the contextual information 525 from the content contextual information generator 520. The video capture parameter determination logic 530 selects an optimal video format for the video containing the desired content from multiple available video formats based on the set of connection quality parameters 515 and the contextual information 525. In one embodiment, the video capture parameter determination logic 530 assigns different weights to each video quality parameter based on the contextual information 525. The video capture parameter determination logic 530 then selects the optimal video format based on the different weights, e.g., by selecting a video format that best matches the weights assigned to different video quality parameters.

In one embodiment, when the set of connection quality parameters 515 indicates that the connection quality between the receiving device 120 and the content server 110 is poor, the video capture parameter determination logic 530 uses a scale function for the importance of each video quality parameter to determine how much each video quality parameter can be degraded. In one embodiment, the scale function is derived partially based on the contextual information 525. For example, different weights are assigned to each video quality parameter based on the contextual information 525, and the more weights a video quality parameter is assigned, the less the video quality parameter is to be degraded.

The video capture parameter determination logic 530 sends video quality parameters 535 that represent the optimal video format to the video capture unit 540. In one embodiment, the video quality parameters 535 include values for codec, frame rate, contrast, brightness, resolution, bit depth, EOTF, and color gamut. The codec is a coding or compression format used for the video. The bit depth specifies the number of bits used for each color component. More bits within a particular dynamic range results in less likelihood of seeing “color banding” (quantization error), which is a problem of inaccurate color presentation in video display. More bits could also be expended on a wider dynamic range. If a wider dynamic range is used, then there is a corresponding need for more bits to maintain constant, and hopefully invisible, quantization error. The color gamut is the complete set of colors found within the video. In one embodiment, the color gamut is the range of color that may be portrayed by a given display device, which is related to the chromaticity coordinates of the color primaries of the display.

The video capture unit 540 captures the video containing the video content using the video quality parameters 535 and sends the captured video 545 to the receiving device 120 through the content server 110. In one embodiment, the captured video containing the video content using the video quality parameters 535 is converted (e.g., transcoded) into various video streams. The content server 110 or the content producer 105 then selects one of the transcoded video streams suitable for the receiving device 120 and sends the selected transcoded video stream to the receiving device.

One of ordinary skill in the art will realize that in other embodiments, this system can be implemented differently. For instance, in one embodiment, instead of determining a single set of connection quality parameters, the connection quality determination logic 510 of the content server 110 can determine multiple sets of connection quality parameters for the receiving devices. In one embodiment, instead of selecting an optimal video format for the video containing the desired content, the video capture parameter determination logic 530 can select multiple video formats for the video containing the desired content from multiple available video formats based on the multiple sets of connection quality parameters and the contextual information 525. In one embodiment, the video capture parameter determination logic 530 assigns different weights to each video quality parameter based on the contextual information 525. The video capture parameter determination logic 530 then selects the multiple video formats based on the different weights, e.g., by selecting video formats that match the weights assigned to different video quality parameters.

In one embodiment, when a set of connection quality parameters indicates that the connection quality between a set of receiving devices and the content server 110 is poor, the video capture parameter determination logic 530 uses a scale function for the importance of each video quality parameter to determine how much each video quality parameter of a video format for the set of receiving devices can be degraded. In one embodiment, the scale function is derived partially based on the contextual information 525. For example, different weights are assigned to each video quality parameter based on the contextual information 525, and the more weights a video quality parameter is assigned, the less the video quality parameter is to be degraded.

The receiving device 120, the content producer 105, and the content server 110 are described above for one embodiment of the invention. One of ordinary skill in the art will realize that in other embodiments, this system can be implemented differently. For instance, in one embodiment described above, certain modules are implemented as software modules. However, in another embodiment, some or all of the modules might be implemented by hardware, which can be dedicated application specific hardware (e.g., an application specific integrated circuit, ASIC, chip or component) or a general purpose chip (e.g., a microprocessor or field programmable gate array, FPGA).

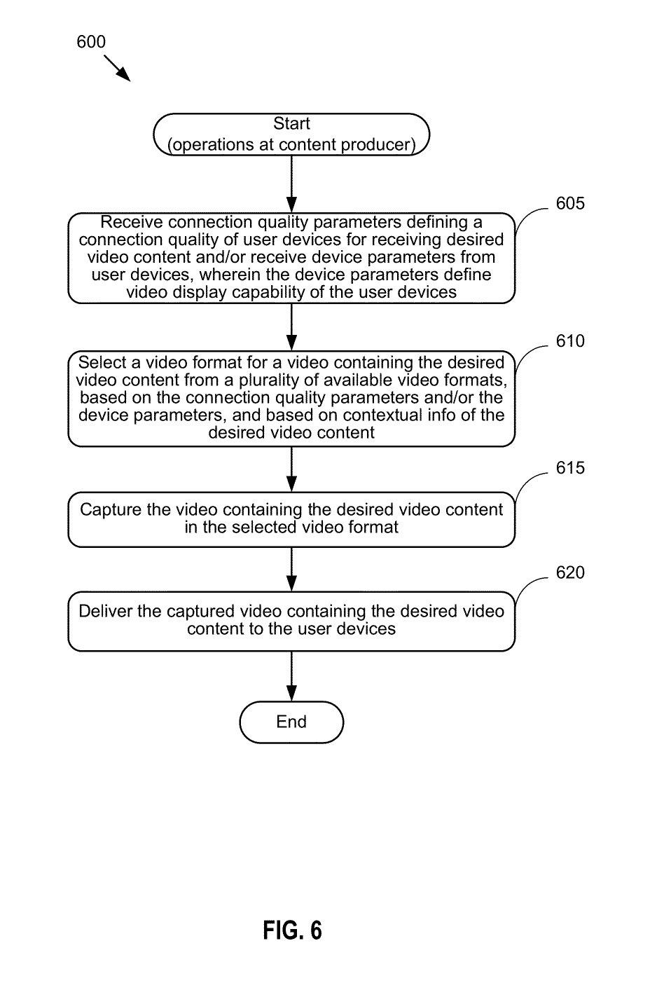

FIG. 6 illustrates a flowchart of operations performed in a center producer, referred to as process 600. In one embodiment, the content producer (e.g., the content producer 105 of FIG. 1 or FIG. 5) executes process 600 when a video content request is initiated. In one embodiment, the video content is streamed live. As illustrated in FIG. 6, process 600 begins by receiving (at block 605) a set of connection quality parameters defining a connection quality of user devices (e.g., the receiving device 120 of FIG. 1 or FIG. 5) for receiving desired video content and/or receiving device parameters from user devices. The device parameters define the capability of the user devices in handling different video quality parameters. In one embodiment, the connection quality parameter represents the maximum bit rate that can be sustained to any one subscriber (user device) to the video content. In one embodiment, the device parameters may include the codec, the frame rate, contrast, brightness, resolution, bit depth, EOTF, and color gamut that the user devices can handle.

At block 610, process 600 selects a video format for the desired video content from several available video formats based on the connection quality parameters and/or the device parameters, and based on contextual information of the desired video content. In one embodiment, the contextual information is the content type of the video, e.g., sports, talk show, reality show, etc. In one embodiment, process 600 assigns different weights to each video quality parameter based on the contextual information of the desired video content. Process 600 then selects the optimal video format based on those different weights, e.g., by selecting a video format that best matches the weights assigned to different video quality parameters. In one embodiment, when the connection quality parameters indicate that the connection quality is poor, process 600 uses a scale function for the importance of each video quality parameter to determine how much each video quality parameter can be degraded. In one embodiment, the scale function is derived partially based on the contextual information of the desired video content. For example, different weights are assigned to each video quality parameter based on the contextual information, and the more weights a video quality parameter is assigned, the less the video quality parameter is to be degraded.

At block 615, process 600 captures the desired video content in the selected video format. At block 620, process 600 delivers the captured video containing the desired video content in the selected video format to the user devices through a content server (e.g., the content server 110 of FIG. 1 or FIG. 5). In one embodiment, process 600 converts (e.g., transcodes) the captured video containing the video content in the selected video format into various video streams. Process 600 then selects one of the transcoded video streams suitable for the user device and sends the selected transcoded video stream to the user device.

One of ordinary skill in the art will realize that in other embodiments, process 600 can be implemented differently. For instance, in one embodiment, instead of receiving a single set of connection quality parameters, process 600 can receive multiple sets of connection quality parameters for the user devices. In one embodiment, instead of selecting a single video format for the desired content, process 600 can select multiple video formats for the desired content from multiple available video formats based on the multiple sets of connection quality parameters and based on the contextual information of the desired content. In one embodiment, process 600 assigns different weights to each video quality parameter based on the contextual information of the desired content. Process 600 then selects the multiple video formats based on the different weights, e.g., by selecting video formats that match the weights assigned to different video quality parameters.

In one embodiment, when a set of connection quality parameters indicates that the connection quality for a set of user devices is poor, process 600 uses a scale function for the importance of each video quality parameter to determine how much each video quality parameter for a video format for the set of user devices can be degraded. In one embodiment, the scale function is derived partially based on the contextual information. For example, different weights are assigned to each video quality parameter based on the contextual information, and the more weights a video quality parameter is assigned, the less the video quality parameter is to be degraded.

One of ordinary skill in the art will recognize that process 600 is a conceptual representation of the operations executed by the content server to stream video to the user device. The specific operations of process 600 may not be performed in the exact order shown and described. The specific operations may not be performed in one continuous series of operations, and different specific operations may be performed in different embodiments. Furthermore, process 600 could be implemented using several sub-processes, or as part of a larger macro process.

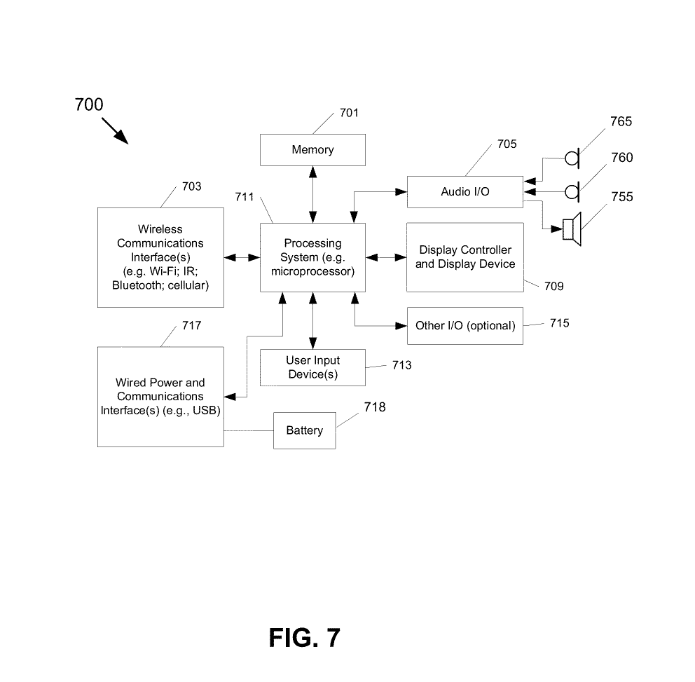

FIG. 7 shows an example of a data processing system 700 which may be used with one embodiment of the invention. Specifically, this figure shows a data processing system 700. The data processing system 700 shown in FIG. 7 includes a processing system 711, which may be one or more microprocessors or a system on a chip integrated circuit. The data processing system 700 also includes memory 701 for storing data and programs for execution by the processing system 711. The data processing system 700 also includes an audio input/output subsystem 705, which may include a primary microphone 765, a secondary microphone 760, and a speaker 755, for example, for playing back music or providing telephone functionality through the speaker and microphones.

A display controller and display device 709 provide a digital visual user interface for the user; this digital interface may include a graphical user interface similar to that shown on a Macintosh computer when running the OS X operating system software, or an Apple iPhone when running the iOS operating system, etc. The system 700 also includes one or more wireless communications interfaces 703 to communicate with another data processing system, such as the system 700 of FIG. 7. A wireless communications interface may be a WLAN transceiver, an infrared transceiver, a Bluetooth transceiver, and/or a cellular telephony transceiver. It will be appreciated that additional components, not shown, may also be part of the system 700 in certain embodiments, and in certain embodiments fewer components than shown in FIG. 7 may also be used in a data processing system. The system 700 further includes one or more wired power and communications interfaces 717 to communicate with another data processing system. The wired power and communications interface may be a USB port, etc., and may connect to a battery 718.

The data processing system 700 also includes one or more user input devices 713, which allow a user to provide input to the system. These input devices may be a keypad or keyboard, or a touch panel or multi touch panel. The data processing system 700 also includes an optional input/output device 715 which may be a connector for a dock. It will be appreciated that one or more buses, not shown, may be used to interconnect the various components as is well known in the art. The data processing system shown in FIG. 7 may be a handheld device or a personal digital assistant (PDA), or a cellular telephone with PDA-like functionality, or a handheld device which includes a cellular telephone, or a media player such as an iPod, or a device which combines aspects or functions of these devices such as a media player combined with a PDA and a cellular telephone in one device or an embedded device or other consumer electronic devices. In other embodiments, the data processing system 700 may be a network computer or an embedded processing device within another device or other type of data processing systems, which have fewer components or perhaps more components than that shown in FIG. 7.

The digital signal processing operations described above, such as encoding and decoding of cellular packets, flow/rate control, packet jitter control, setup or pickup of telephone call, and the audio signal processing including for example filtering, noise estimation, and noise suppression, can all be done either entirely by a programmed processor, or portions of them can be separated out and be performed by dedicated hardwired logic circuits.

The foregoing discussion merely describes some exemplary embodiments of the invention. One skilled in the art will readily recognize from such discussion, from the accompanying drawings, and from the claims that various modifications can be made without departing from the spirit and scope of the invention.

What is claimed is:

1. A method for delivering desired video content over a packet-switching data communications network comprising:
receiving a plurality of device parameters from a user device, wherein the plurality of device parameters defines video display capability of the user device;
selecting a video format for a video containing a desired video content from a plurality of video formats based on the plurality of device parameters and based on a contextual information of the desired video content; and
streaming the video containing the desired video content in the selected video format into the packet-switching data communications network.

2. The method of claim 1 further comprising retrieving the video containing the desired video content in the selected video format from a media library.

3. The method of claim 1, wherein the plurality of device parameters define a capability of the user device in handling a plurality of video quality parameters, wherein the plurality of video quality parameters comprises one or more of codec, frame rate, contrast, brightness, resolution, bit depth, Electronic-to-Optical Transfer Function (EOTF), and color gamut.

4. The method of claim 3, wherein the selecting of the video format comprises:
assigning a weight to each video quality parameter based on the contextual information of the desired video content; and
selecting the video format based on the weights assigned to the plurality of video quality parameters.

5. The method of claim 1, wherein the contextual information specifies content type of the desired video content.

6. The method of claim 5, wherein content types comprise feature film, sports, documentary, talk show, television comedy, and reality show.

7. A system for delivering desired video content comprising:
a processor; and
a video format selection logic that is to:
receive a plurality of device parameters from a user device, wherein the plurality of device parameters defines video display capability of the user device;
select a video format for a video containing the desired video content from a plurality of video formats based on the plurality of device parameters and based on a contextual information of the desired video content; and
stream the video containing the desired video content in the selected video format to the user device.

8. The system of claim 7, wherein the video format selection logic is further to retrieve the video containing the desired video content in the selected video format from a media library.

9. The system of claim 7, wherein the plurality of device parameters define a capability of the user device in handling a plurality of video quality parameters, wherein the plurality of video quality parameters comprises one or more of codec, frame rate, contrast, brightness, resolution, bit depth, Electronic-to-Optical Transfer Function (EOTF), and color gamut.

10. The system of claim 9, wherein the video format selection logic selects the video format by:
assigning a weight to each video quality parameter based on the contextual information of the desired video content; and
selecting the video format based on the weights assigned to the plurality of video quality parameters.

11. The system of claim 7, wherein the contextual information specifies content type of the desired video content.

12. The system of claim 11, wherein content types comprise feature film, sports, documentary, talk show, television comedy, and reality show.

13. The system of claim 7, wherein the video is streamed into a packet-switching data communication network for delivery to the user device.

14. A system for streaming video content comprising:
a processor;
a parameter determination logic that is to select a video format for a video containing video content from a plurality of video formats based on a plurality of parameters defining a connection quality of users subscribed to receive the video content and based on contextual information of the video content; and
a video capture unit that is to capture the video containing the video content in the selected video format.

15. The system of claim 14, wherein the video capture unit is further to deliver the video containing the video content to a content server.

16. The system of claim 14, wherein the plurality of parameters comprises a maximum bit rate that can be sustained to any one subscriber to the video content.

17. The system of claim 14, wherein the contextual information of the video content specifies content type of the video content.

18. The system of claim 17, wherein content types comprise sports, talk show, and reality show.

19. The system of claim 14, wherein the parameter determination logic selects the video format by:
assigning a weight to each video quality parameter based on the contextual information of the video content; and
selecting the video format based on the weights assigned to different video quality parameters.

20. The system of claim 14, wherein the video capture unit is further to convert the video containing the video content from the selected video format into a set of video formats.
